(19) United States
(12) Patent Application Publication
(10) Pub. No.: US 2005/0162253 A1
(43) Pub. Date: Jul. 28, 2005

(54) Authentication and access control via wireless communication

(76) Inventors: W. Neil Wilson, Easley, SC (US); David S. Condrey, Greenville, SC (US)

Correspondence Address: John B. Hardaway, III;NEXSEN PRUET, LLC, P.O. Box 10107, Greenville, SC, 29603, US

(21) Appl. No.: 10/762,844

(22) Filed: Jan. 22, 2004

(51) Int. Cl. H04Q 1/00; G05B 19/00

(52) U.S. Cl. 340/5.2; 340/5.51; 340/5.6

(57) ABSTRACT

A system and method for authenticating and authorizing use of physical equipment. The system includes a conventional computer network having a central computer gateway, at least one system-access detector connected to the central computer gateway and having a unique location identification, and at least one client identifier coupled with the physical equipment and having a unique client identification. The method includes providing a wireless system for communication between a client identification unit and at least one system-access detector connected to a central computer gateway of a wide-area computer network; connecting the client identification unit with the control system of the physical equipment; obtaining operator identification at the client identification unit; transmitting authentication and identification of the client identification unit to the central computer gateway; transmitting data between the computer network and the central computer gateway; and permitting activation and monitoring of the physical equipment connecting the controller board with the control system of the physical equipment; enabling secure authentication and identification of the controller board; communicating authentication and identification of the controller board to the computer network; transmitting data between the computer network and the controller board; and, permitting activation and monitoring of the physical equipment.

### FIELD OF THE INVENTION

This invention relates to systems and methods of authentication and access control and, more specifically, to a system, apparatus and method for authenticating and authorizing the use of physical equipment via a secure wireless protocol and incorporating information about such physical equipment into a computing network to facilitate authentication and authorization.

### BACKGROUND OF THE INVENTION

Organizations, such as companies or corporations, rely on internal computing infrastructure to implement access and control of company data and other computing resources, such as servers, workstations, intranet, and business data. For example, a business network contains mechanisms for controlling access to such network in the form of passwords and user identification. Commonly, a computer user must authenticate to the network in order to use a computer workstation that is connected on the network. Authentication involves verification of the identity of the computer user by entry of a password and a user identification, intended to be known only by the computer user, prior to accessing the network.

Most organizations also possess physical items such as vehicles and other tangible equipment or supplies that may have real value to the organization. Typically, an operator desiring to use a piece of equipment must authenticate to the business network in order to use such item, such as by written checkout. This rudimentary procedure provides minimal information regarding the status and location of the physical item and provides only minimal control of access (e.g., at the time of operator authentication to the network). However, little has been done to place physical items into these business networks such that access to the items may be controlled through the network itself. What is needed is an improved system and method of authentication and access control. More particularly, what is needed is a system and method of authenticating and authorizing use of an inventory of physical equipment using business networks via secure wireless communication.

### SUMMARY OF THE INVENTION

An object of this invention is to provide a system and method for authenticating and authorizing use of physical equipment.

Another object of this invention is to provide a system and method for authentication and access control using business networks via wireless connections.

Another object of this invention is to provide a system for unique identification of physical equipment.

Another object of this invention is to provide authentication and identification of physical equipment with high confidence.

A more particular object of this invention is to provide a system for authentication and authorization of physical equipment use that communicates reasons for permitting or refusing use.

A further object of this invention is to provide a system for authenticating and authorizing physical equipment use that wirelessly communicates data between a host business network and the physical equipment.

These and other objects of the invention are accomplished by providing a system and method for authenticating and authorizing use of physical equipment. The system includes a conventional computer network having a central computer gateway, at least one system-access detector connected to the central computer gateway and having a unique location identification, and at least one client identifier coupled with the physical equipment and having a unique client identification.

Each of the system-access detectors is preferably located to optimize accurate tracking of each of the physical equipment. When a physical equipment moves within a pre-determined detection zone occupied by a system-access detector, such system-access detector communicates with the client identifier associated with the physical equipment. This communication is preferably accomplished using secure wireless communication, and the unique client identification is provided by the client identifier to the particular system-access detector. The system-access detector transmits the client identification as well as the unique location identification associated with such detector to the computer gateway. The computer network associated with the computer gateway can thereby monitor the status of the physical equipment and control access to the same.

These and other objects of the invention are also accomplished by providing a method for authenticating and authorizing use of physical equipment. The method includes: providing a wireless system for communication between a controller board and a central computer gateway of a wide-area computer network; connecting the controller board with the control system of the physical equipment; enabling secure authentication and identification of the controller board; communicating authentication and identification of the controller board to the computer network; transmitting data between the computer network and the controller board; and, permitting activation and monitoring of the physical equipment.

### BRIEF DESCRIPTION OF THE DRAWINGS

FIG. 1 is a diagram of equipment or client tracking in accordance with one exemplary application of the present invention.

FIG. 2 is a diagram of a two access point gateway in accordance with one embodiment of the present invention.

FIG. 3 is a diagram of an access point in accordance with the present invention.

FIG. 4 is a diagram of a client identifier unit in accordance with the present invention.

### DETAILED DESCRIPTION OF THE INVENTION

The present invention is a system and method of authentication and access control using business networks and wireless communication. In particular, the system authenticates and authorizes use of tangible items, such as physical equipment and supplies, based on unique identifiers associated with each operator and corresponding item. The system and method are ideally suited for use with conventional wide area networks (WAN) such that a home office can control authentication and authorization of equipment use via secure wireless communication. Additionally, the system and method provide for authentication and authorization of equipment use while also communicating reasons for permitting or refusing use and monitoring equipment status.

In a most basic form, the system includes a computer network having a central computer gateway, at least one system-access detector unit connected to the central computer gateway and having a unique location identification associated therewith, and at least one client identifier unit having a unique client identification associated therewith. A client identifier unit is coupled with each piece of equipment that is desired to be within the purview of system authentication and access control. For simplification of reference, “client” as used herein is defined as a piece of equipment having a client identifier unit coupled therewith. Each of the system-access detectors and client identifier units preferably have spread spectrum data transceivers, such as 900 MHz frequency-hopping spread spectrum (FHSS) data radios.

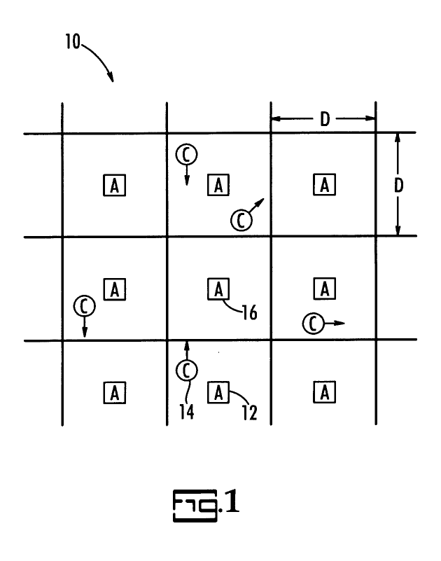

FIG. 1 is a diagram of equipment or client tracking in accordance with one exemplary application of the present invention. Access points, A, each having a system-access detector, are geographically located depending on a number of equipment or clients, C, that are desired to be tracked/monitored and on limitations with communication range among various system components. Each system-access detector, and hence access point A, has a zone of coverage based on the communication range of the data radios, and each system-access detector identifies any clients C within a respective zone of coverage by obtaining the client identification associated with the client identifier unit.

In this embodiment of the present invention, the access points A are positioned to form a grid-shaped pattern, shown generally at 10. Each access point A has a square shaped-zone of coverage associated therewith, and each access point A is centrally located within a respective zone of coverage. Each zone of coverage has a side dimension, D, that is determined by the communication range of the data radio associated with the system-access detector. Although a square-shaped zone of coverage is described in connection with each access point, the shape of the zone of coverage is not critical to the operation of the system and other shapes for the zone of coverage may be used depending on the communication range of the system-access detectors. Clients C may roam from one zone of coverage to another zone of coverage. As the client C moves, each system-access detector detects and identifies any new equipment within the detector's zone of coverage. For example, a client 14 that is located within the zone of coverage for an access point 12 is detected by the associated system-access detector. As the client 14 moves out of the zone of coverage for this access point 12 and into the zone of coverage for an adjacent access point 16, the system-access detector of the adjacent access point 16 detects the client 14.

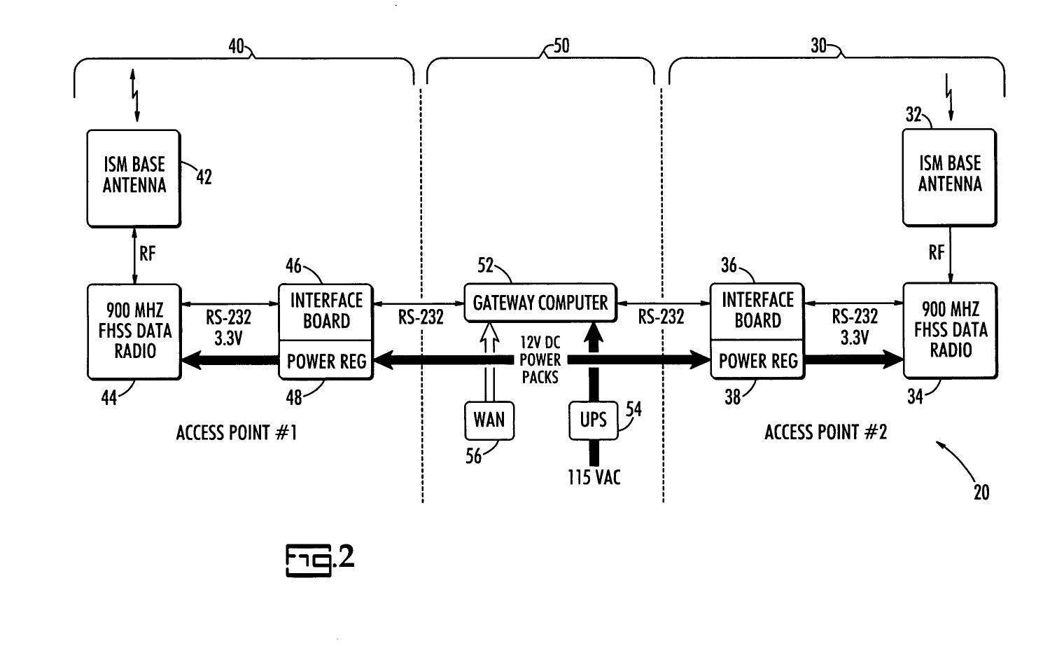

FIG. 2 is a diagram of a two access point gateway, shown generally at 20, in accordance with one embodiment of the present invention. In this embodiment, two access points are connected to a central gateway 50. As previously mentioned, each access point includes a system-access detector 30, 40. Although two system-access detectors are shown and described in this embodiment, the system is scalable depending on the number of equipment or clients that are desired to track. Multiple access points, and hence multiple system-access detectors, may be used with the system, and the system is scalable based on the number of clients requiring service and a desired update rate regarding the client status.

Each of the system-access detectors 30, 40 includes a controller having an interface board 36, 46 and a spread spectrum data transceiver 34, 44 connected to the interface board 36, 46 via conventional serial communication cable, such as RS-232 type cable. The interface board 36, 46 contains electronic hardware for communicating data between a gateway processor of the central gateway computer, described in greater detail hereinbelow, and the spread spectrum data transceiver 34, 44. The spread spectrum data transceiver 34, 44 is selected from direct sequence spread spectrum (DSSS) data radios and frequency-hopping spread spectrum (FHSS) data radios, and FHSS data radios are preferably used for secure wireless communications. The spread spectrum data transceiver 34, 44 includes an antenna 32, 42 to facilitate transmission and reception of data to and from client identifier units, described in greater detail hereinafter.

The spread spectrum data transceiver preferably operates in a frequency range or band that does not require government license such as from the Federal Communications Commission (FCC). An example of a suitable antenna used with the transceiver includes an Industrial Scientific Medical (ISM) band base antenna. Omni-directional antennae are preferably used. ISM band ranges typically encompass about 900 MHz through about 5.925 GHz frequencies and do not normally require FCC approval for operation therein.

The interface boards 36, 46 include microcontrollers or microprocessors for coordinating and controlling communication between the system-access detectors and the gateway 50. General purpose microcontrollers may be used including, by way of example and not limitation, Microchip 18LF6xxx-I/PT series microcontrollers and Motorola MC9S08GTxxCFB series microcontrollers. In a preferred embodiment, the microcontroller includes two (2) asynchronous serial ports (e.g., universal synchronous asynchronous receiver transmitters, or USARTs, also known as serial communications interface, or SCI), at least four (4) spare digital input pins and four (4) digital output pins, at least 512 bytes of static random access memory (RAM), at least 512 bytes of non-volatile memory (e.g., non-volatile random access memory, or NVRAM, including implementations using electrically eraseable programmable read-only memory, or EEPROM, or flash memory), at least two spare 16-bit timers, and operates on a 3.3 volt supply having low current consumption (e.g., under 25 mA in non-sleep mode).

The gateway 50 includes a gateway processor 52, such as a conventional personal computer, that is connected to a business network via wide area network (WAN) or other conventional network structures. An uninterruptible power supply (UPS) 54 is connected to the gateway processor 52 to provide power for operation of the gateway processor 52. The power source for the UPS is preferably 115 volt AC. Portable power supplies provide power to the access points 30, 40. For example, a power pack such as a 12 volt DC power pack is connected to a power regulator 38, 48 that is in turn electrically connected with the interface board 36, 46.

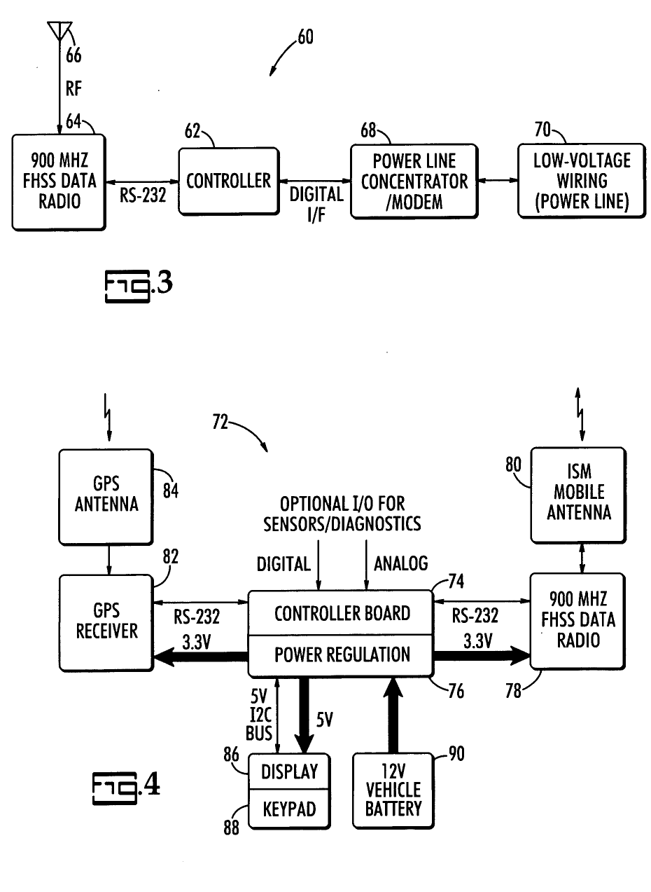

FIG. 3 is a diagram of an access point in accordance with the present invention. As previously mentioned, each access point has a system-access detector, shown generally at 60. The system-access detector 60 has a media access control (MAC) address and Internet protocol (IP) address associated therewith to uniquely identify the system-access detector 60 by location. The system-access detector 60 may be installed on structures with desirable line-of-sight coverage to maximize the zone of coverage available for each detector. For example, the system access detector 60 may be installed on taller structures, such as billboards and tall signs, that are centrally located within each grid square zone of coverage.

The spread spectrum data transceiver 64 is connected to the controller 62 via conventional serial communication cable, such as RS-232 type cable. The spread spectrum data transceiver 64 is selected from direct sequence spread spectrum (DSSS) data radios and frequency-hopping spread spectrum (FHSS) data radios, and FHSS data radios are preferably used for secure wireless communications. An antenna 66 is connected to the spread spectrum data transceiver 64 to facilitate transmission and reception of data to and from client identifier units. The controller 62 is connected via digital I/F to a power line concentrator/modem 68 that is connected to low-voltage wiring 70 for power supply. The power line concentrator/modem 68 facilitates transmission of data to and from the controller 62.

The spread spectrum data transceiver 64 operates in a continuous or intermittent scan or detect mode to receive transmission from the client identifier units. For example, the information regarding the location and status of the client identifier units, and thus the associated equipment, is received by the data spread spectrum transceiver 64 and forwarded by the controller 62 to the central gateway 50. The central gateway 50 may relay such information to the business network via WAN so that the location and status of each active client identifier unit is accessible on the business network.

FIG. 4 is a diagram of a client identifier unit in accordance with the present invention. The client identifier unit 72 is preferably mounted to a particular physical equipment so as to intimately reflect the status of and affect access to the same. The client identifier unit 72 includes a controller board 74 having power regulation 76 and a spread spectrum data transceiver 78 connected to the controller board 74 using conventional serial communication cable, such as RS-232 type cable. The spread spectrum data transceiver 78 is selected from direct sequence spread spectrum (DSSS) data radios and frequency-hopping spread spectrum (FHSS) data radios. FHSS data radios are preferably used for secure wireless communications. The spread spectrum data transceiver 78 includes an antenna 80 to facilitate transmission and reception of data to and from client identifier units. An example of a suitable antenna includes an ISM band base antenna.

A global positioning receiver 82, such as conventionally used with Global Positioning System (GPS), and GPS antenna may optionally be coupled to the controller board 74 to provide global positioning information regarding the location of the global positioning receiver 82 as well as the location of the corresponding physical equipment. Additionally, an operator identification unit is connected with the controller board 74 using a universal 2-wire bus, such as a 5 volt I2C bus, to provide an operator interface for authentication and access control. The operator identification unit may include a conventional display 86, such as a cathode ray tube (CRT) type, liquid crystal display (LCD) or other conventional image display, and keypad 88 or keyboard. The controller board 74 optionally includes inputs and outputs for sensors and diagnostics. A unique physical equipment identification (ID) is stored in a ROM component of the controller board 74 of the client identifier unit 72. An example of a suitable equipment ID is the use of a Media Access Control (MAC) address. Additionally, i-button or other user identification devices may be used.

Power to the client identifier unit 72, such as from a 12 V battery, is supplied to the power regulation 76. The power regulation 76 in turn supplies power to the spread spectrum transceiver 78 and the optional GPS receiver 82.

In one example, the client identifier unit is integrated with a piece of equipment, such as a golf cart, such that use of the golf cart is permitted when an operator has completed identification and authentication. An electronic switching mechanism connected to a control system of the golf cart may be used with the client identifier unit to permit activation of the golf cart. Power is supplied to the client identifier unit using a 12 V vehicle battery found on-board the golf cart. In the event the equipment does not have a separate on-board power supply, the client identifier unit may be coupled to a portable power supply, such as a DC battery.

The controller board runs system applications that require operator identification and authentication in order to use the corresponding equipment, and the system applications query for operator identification and authentication. After the operator provides an operator identification to the client identification unit by interfacing with the operator identification unit, the controller board transmits the equipment ID, equipment location information, and operator identification to the central gateway by transmitting such information using the FHSS data radio. Examples of operator identification include a token, key, badge, password, pass phrase, and biometrics such as a fingerprint, retina pattern, and genetic identification.

Equipment location information may be derived from the optional GPS receiver 82 that is connected to the client identifier unit 74. Once the global position of the client identifier unit 74 is determined by the GPS receiver 82, the controller board 74 transmits the global position information using the spread spectrum data transceiver 78. Alternatively, the relative location information of the client identifier unit 74 may be derived based on detection of the client identifier unit 74 in a particular zone of coverage for an access point. For example, the FHSS data radio associated with a particular client identification unit may continuously or intermittently transmit equipment ID and/or operator identification for reception by the FHSS data radio associated with a particular system-access detector. Optionally, the equipment location information may include relative or absolute altitude of the associated equipment so as to provide three-dimension equipment location. The controller for such system-access detector then conveys the MAC address and IP address associated with the system-access detector to the central gateway 50.

In a most basic form, the method includes providing a wireless system for communication between a client identification unit and at least one system-access detector connected to a central computer gateway of a WAN; connecting the controller board with the control system of the physical equipment; enabling secure authentication and identification of the controller board; communicating authentication and identification of the controller board to the computer network; transmitting data between the computer network and the controller board; and, permitting activation and monitoring of the physical equipment.

The present invention is ideally suited for use with broadband over power line (BPL) communication transmission systems. BPL systems are a type of carrier current system that operate on an unlicensed basis under FCC rules. BPL systems use existing electrical power lines as a transmission medium to provide high-speed communication capabilities by coupling radio frequency (RF) energy onto the power line. BPL systems may operate either inside a building, termed “in-house BPL”, or over utility poles and medium voltage electric power lines, termed “access BPL”.

Carrier current systems transmit RF energy by conduction over the electric power line to a receiver that is also connected to the same power line. Carrier current systems can be designed such that signals are received by conduction directly from connection to the electric power line, or unintentional radiator. Alternatively, carrier current systems can be designed such that the signals are received over-the-air, due to radiation of RF signals from the power line, or intentional radiator. BPL devices operate on multiple carriers that are spread over a wide spectrum (e.g., from 4.5 MHz to 21 MHz) with adapative algorithms to counter noise in the power line.

Access BPL systems carry high-speed data and voice signals outdoors over medium voltage lines from a point where there is a connection to a telecommunications network (e.g., to provide Internet access). This point of connection may be at a power substation or at an intermediate point between substations depending on network topology. Near a distribution point, a coupler or bridge circuit module is installed to enable the transfer of high-frequency digital signals across a low-voltage distribution transformer. The high-speed communication signals are brought to the end-user over an exterior service power cable from the bridge across the distribution transformer, either directly or via an access BPL adaptor module.

As previously mentioned with regard to FIG. 3, the controller 62 is connected via digital I/F to a power line concentrator/modem 68 that is connected to low-voltage wiring 70 for high-speed communication using BPL systems. When using BPL systems, the access BPL adaptor module is the digital I/F and power line concentrator/modem 68 to facilitate transmission of data to and from the controller 62.

Those of ordinary skill in the art will be aware of other variations that are within the scope of the claimed invention, which is to be measured by the following claims.

1. A system for authentication and authorization of physical equipment use comprising:
a computer network having a central computer gateway;
at least one system-access detector having a location identification, said at least one system-access detector interfacing with said central computer gateway; and
at least one client identifier unit having a client identification and located with the equipment, said client identifier unit communicating with at least one of said at least one system-access detector.

2. A system according to claim 1, wherein said location identification of each of said at least one system-access detector comprises a media access control (MAC) address and an Internet protocol (IP) address.

3. A system according to claim 1, wherein each of said client identification of each of said at least one client identifier unit comprises a MAC address.

4. A system according to claim 1, wherein each of said at least one client identifier unit further comprises:
a controller coupled with the physical equipment, said controller having means for identifying an operator of the physical equipment; and
a spread spectrum data transceiver connected with said controller, said spread spectrum data transceiver communicating data between said controller and at least one of said at least one system-access detector.

5. A system according to claim 4 further comprising a positioning receiver connected with said controller, said positioning receiver providing a global position of said positioning receiver to said controller.

6. A system according to claim 4, wherein said spread spectrum data transceiver is selected from a direct sequence spread spectrum data transceiver and a frequency-hopping spread spectrum data transceiver.

7. A system according to claim 4, wherein said identifying means detects at least one of a token, a key, a badge, a password, and a biometric.

8. A system according to claim 1, wherein said client identifier unit further comprises a display connected to said controller and a keyboard connected to said controller.

9. A system according to claim 1, wherein each of said at least one system-access detector comprises:
a controller having an interface board connected with said central computer gateway; and
a spread spectrum data transceiver connected with said controller, said spread spectrum data transceiver communicating data between said controller and at least one of said at least one client identifier unit.

10. A system according to claim 9, wherein said spread spectrum data transceiver is connected to an industrial scientific medical (ISM) band base antenna; and wherein said spread spectrum data transceiver operates in a frequency range from about 900 MHz to about 6 GHz.

11. A system according to claim 1, wherein each of said at least one system-access detector is positioned at a pre-determined distance from another of said at least one system-access detector, said pre-determined distance based on a zone of coverage of each of said at least one system-access detector.

12. A system for authentication and authorization of physical equipment use comprising:
a central computer gateway connected to a WAN;
at least one system-access detector connected with said central computer gateway, each of said at least one system-access detector having a MAC address and an IP address corresponding to a physical location identification; and
at least one client identifier unit having a client identification and located with the equipment, said client identifier unit wirelessly communicating with at least one of said at least one system-access detector.

13. A system according to claim 12, wherein each of said at least one client identifier unit further comprises:
a controller board electrically coupled with the physical equipment;
an operator identification unit connected to said controller board of said client identifier unit; and
a spread spectrum data transceiver connected with said controller board, said spread spectrum data transceiver communicating data between said controller board and at least one of said at least one system-access detector.

14. A system according to claim 13 further comprising a positioning receiver connected with said controller board, said positioning receiver providing a global position of said positioning receiver to said controller board.

15. A system according to claim 13, wherein said spread spectrum data transceiver is a frequency-hopping spread spectrum data radio.

16. A system according to claim 13, wherein said operator identification unit detects at least one of a token, a key, a badge, a password, a phrase, a fingerprint, a genetic identification, and a retina pattern.

17. A system according to claim 13, wherein said client identifier unit further comprises a display connected to said controller and a keyboard connected to said controller board.

18. A system according to claim 1, wherein each of said at least one system-access detector comprises:
a controller having an interface board connected with said central computer gateway; and
a spread spectrum data transceiver connected with said controller, said spread spectrum data transceiver communicating data between said controller and at least one of said at least one client identifier unit.

19. A system according to claim 1, wherein said computer network comprises a database having at least one of profiles representing each individual user, profiles representing groups of individual users, profiles representing each physical equipment, profiles representing physical areas based on absolute or relative geographic coordinates, and sets of permissions allowing user access to physical equipment.

20. A system according to claim 1, wherein said computer network comprises profiles for a given device configuration, said profiles comprising binary codes to be used by devices defined to the network, and said network providing and modifying said binary codes relating to said devices.

20. A method for authentication and authorization of physical equipment having a control system, said method comprising the steps of:
providing a wireless system for communication between a client identification unit and at least one system-access detector connected to a central computer gateway of a WAN;
connecting the client identification unit with the control system of the physical equipment;
obtaining operator identification at the client identification unit;
transmitting authentication and identification of the client identification unit to the central computer gateway;
transmitting data between the computer network and the central computer gateway; and
permitting activation and monitoring of the physical equipment.

21. A method according to claim 20, wherein said communicating step comprises:
transmitting equipment identification and operator identification of the client identification unit to at least one system-access detector; and
transmitting authentication and identification of the client identification unit between the system-access detector and the central computer gateway.
